(19) United States
(12) Patent Application Publication
(10) Pub. No.: US 2015/0348214 A1
(43) Pub. Date: Dec. 3, 2015

(54) MESSAGING SERVICE FOR GEOFENCE-BASED AUTOMATIC TIME CLOCKING

(71) Applicant: SHAILENDRA JAIN, Palo Alto, CA (US)

(72) Inventor: SHAILENDRA JAIN, Palo Alto, CA (US)

(21) Appl. No.: 14/289,496

(22) Filed: May 28, 2014

(51) Int. Cl. G06Q 40/00; H04W 4/02; G06Q 30/02

(52) U.S. Cl. CPC G06Q 40/125; G06Q 30/0261; H04W 4/02

(57) ABSTRACT

In one exemplary embodiment, a method includes creating a virtual perimeter around a geographic region. The geographic region within the virtual perimeter is assigned a job-site number. A location of a user's mobile device is tracked. It is determined when a user enters the geographic region defined by the virtual perimeter. The time that the user is in the geographic region is recorded. The time the user is in the virtual perimeter can be assigned to a time sheet of the user as an employee of a company. It can be detected that the user has left the geographic region. The recording of the time that the user is in the geographic region can be ceased. The excused period to be outside the geographic region can be automatically determined from information in the user's mobile device calendar or in a list of assignments associated with the user. The geographic region can be a physical work site.

### CROSS-REFERENCE TO RELATED APPLICATIONS

This application is a claims priority to U.S. patent application Ser. No. 13/769,806, titled MESSAGING SERVICE FOR LOCATION-AWARE MOBILE RESOURCE MANAGEMENT AND ADVERTISEMENTS WITH A MOBILE DEVICE TRIGGERED BY TAGGED USER-GENERATED MESSAGES and filed on Feb. 18, 2013. U.S. patent application no. claims priority to U.S. patent provisional application No. 61/600,706 titled MESSAGING SERVICE FOR LOCATION-AWARE MRM AND/OR ADVERTISEMENTS WITH A MOBILE DEVICE TRIGGERED BY TAGGED USER-GENERATED MESSAGES and filed on Feb. 19, 2012. These applications are hereby incorporated by reference in their entirety.

### BACKGROUND

1. Field

This application relates generally to location-based services, and more particularly to a system, method and article of manufacture of manufacture of geofence-based automatic time clocking.

2. Related Art

A company may have employees that work at remote job locations. The company may wish to track the employee's time at the remote job location. However, sign in sheets or other methods by which an employee clocks in may rely on the employee's self-reporting. Verification of such clock-in/clock-out methods may not be feasible and/or costly. Therefore, improvements to the methods and systems of tracking employee work time at remote job locations may prove beneficial.

### BRIEF SUMMARY OF THE INVENTION

In one aspect, a method includes creating a virtual perimeter around a geographic region. The geographic region within the virtual perimeter is assigned a job-site number. A location of a user's mobile device is tracked. It is determined when a user enters the geographic region defined by the virtual perimeter. The time that the user is in the geographic region is recorded.

Optionally, the time the user is in the virtual perimeter can be assigned to a time sheet of the user as an employee of a company. It can be detected that the user has left the geographic region. The recording of the time that the user is in the geographic region can be ceased. The excused period to be outside the geographic region can be automatically determined from information in the user's mobile device calendar or in a list of assignments associated with the user. The geographic region can be a physical work site. An aggregated time that the user is in the geographic region for a specified period is provided as payroll information for the user for the specified period.

In another aspect, a method include geofencing a geographic region. A telephonic communication from a landline telephone used by an employee is received. The landline telephone is located in the geographic region. A check-in code from an employee input into the landline telephone during the telephonic communication is received. An employee identifier input into the landline telephone during the telephonic communication is received. The employee's mobile device is located. It is determined that employee's mobile device is within the geographic region. The employee is clocked in when both the check-in code from the landline telephone and the location of the mobile device indicate that the employee is within the geographic region.

### BRIEF DESCRIPTION OF THE DRAWINGS

The present application can be best understood by reference to the following description taken in conjunction with the accompanying figures, in which like parts may be referred to by like numerals.

FIG. 1 depicts an example process of geofence-based automatic time clocking, according to some embodiments.

FIG. 2 depicts an example process of geofence-based automatic time clocking, according to some embodiments.

FIG. 3 illustrates an example report generated by a geofence-based time clocking, according to some embodiments.

FIG. 4 illustrates an example user-interface view of a region defined by a geo-fencing methodology, according to some embodiments.

FIG. 5 illustrates an example employee attendance record generated with geofence-based check-in and/or check-out service, according to some embodiments.

FIG. 6 illustrates an example user-interface view that enables a user (e.g. a supervisor) to create various jobsites with geofence-based check-in and/or check-out events, according to some embodiments.

FIG. 7 depicts an example user-interface view that enables an employee to check-in and/or check-out of a jobsite using text messaging with geofence-based verification, according to some embodiments.

FIG. 8 is a block diagram of a sample computing environment that can be utilized to implement some embodiments.

FIG. 9 depicts an exemplary computing system that can be configured to perform any one of the processes provided herein.

FIG. 10 illustrates an example process of using geofencing to generate a clock-in/clock out report for an employee, according to some embodiments.

The Figures described above are a representative set, and are not an exhaustive with respect to embodying the invention.

### DESCRIPTION

Disclosed are a system, method, and article of manufacture of geofence-based automatic time clocking. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Geo-fence can be a virtual perimeter for a real-world geographic area. In various embodiments, a geo-fence can be dynamically generated (e.g. as in a radius around a store or point location specified by a system administrator and/or based on a job-related location). A geo-fence can be a predefined set of boundaries (e.g. a work-place zone(s), neighborhood boundaries, etc.). Custom-digitized geofences can also be utilized.

Landline telephone can be a telephone that uses a metal wire telephone line for transmission.

Location-based services (LBS) can be a class of computer program-level services that use location data to control features. LBS can use information of a geographical position of a mobile device. LBS can include tracking a mobile device's location.

Mobile device can be a portable computing device such as a smart phone, personal digital assistant, wearable computing device (e.g. smart watches and/or other electronic devices that are worn by the bearer under, with or on top of clothing), head-mounted display (e.g. smart glasses such as Google Glass®), tablet computer, and the like. Mobile devices can include systems for determining and/or assisting in determining a location of the mobile device (e.g. GPS, A-GPS, network-assisted location services, etc.).

Time clocking can include tracking the hours worked by an employee of a company.

Process Overview

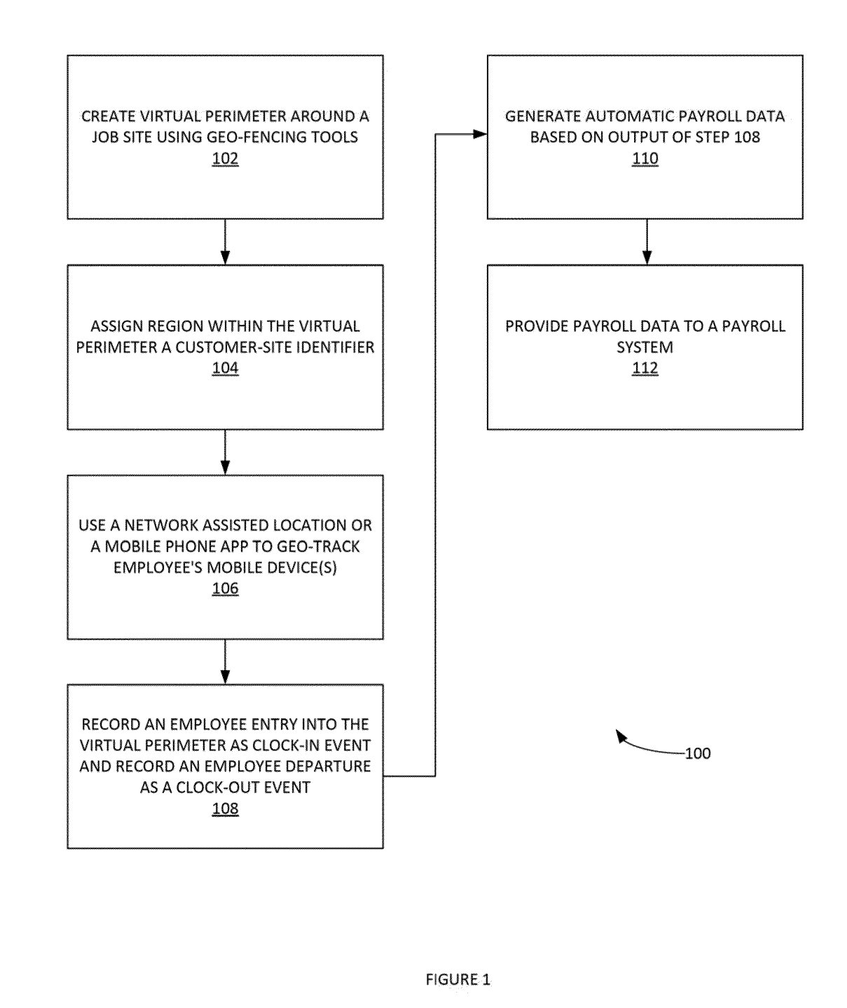

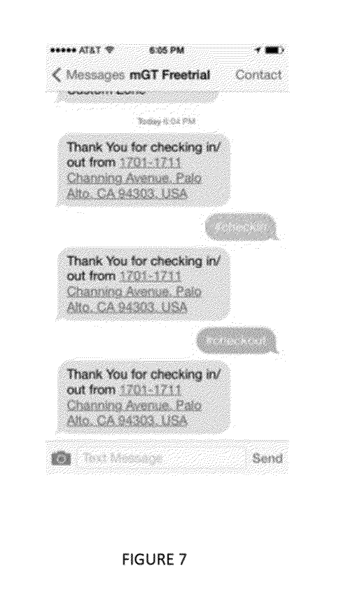

FIG. 1 depicts an example process 100 of automatic time clocking, according to some embodiments. In step 102 of process 100, a virtual perimeter can be created around a job site (e.g. a location where an employee performs employment-related activities). A job site can be a construction site, a delivery route, an office building, a school, etc. For example, geo-fencing methodologies can be implemented to define a region associated with a job site. In one example, virtual perimeters can be generated and defined by system administrators (e.g. supervisors, etc.). In another example, virtual perimeters can be automatically generated and defined based on such factors as a job location, job type (e.g. a city-wide virtual perimeter for a delivery driver, a room-sized virtual perimeter for an office worker, etc.). In step 104, the region within the virtual perimeter can be assigned a customer-site identifier. In this way, a customer of an entity that provides process 100 as a service can be differentiated from other customers. Employees of the customer can also be assigned identifier numbers. The employees can be geotracked (e.g. location determined on a periodic basis) in step 106. For example network-assisted location methods and/or a mobile device application can be used to obtain the employee's current location (e.g. assuming networking and processing latencies and the like). In step 108, an employee's entry into the region defined by the virtual perimeter can be recorded as a clock-in event (e.g. register employee's arrival at work). Similarly, an employee's departure from the region defined by the virtual perimeter can be recorded as a clock-out event (e.g. register employee's departure from work). In step 110, the output of step 108 can be used to automatically generate payroll data. In step 112, the payroll data can be provided to a payroll system (e.g. a customer's payroll system via an electronic message and/or an application programming interface (API)). It is noted that process 100 can be ‘zero touch’ in that employee clock-in and/or clock-out events are determined by an LBS (e.g. the location of the employee's mobile device). In another example, process 100 can be used in a text based clock-in and/or clock-out system with LBS verification (e.g. see FIG. 7 infra). In another example, process 100 can be used in an interactive-voice based clock-in and/or clock-out system with double LBS verification.

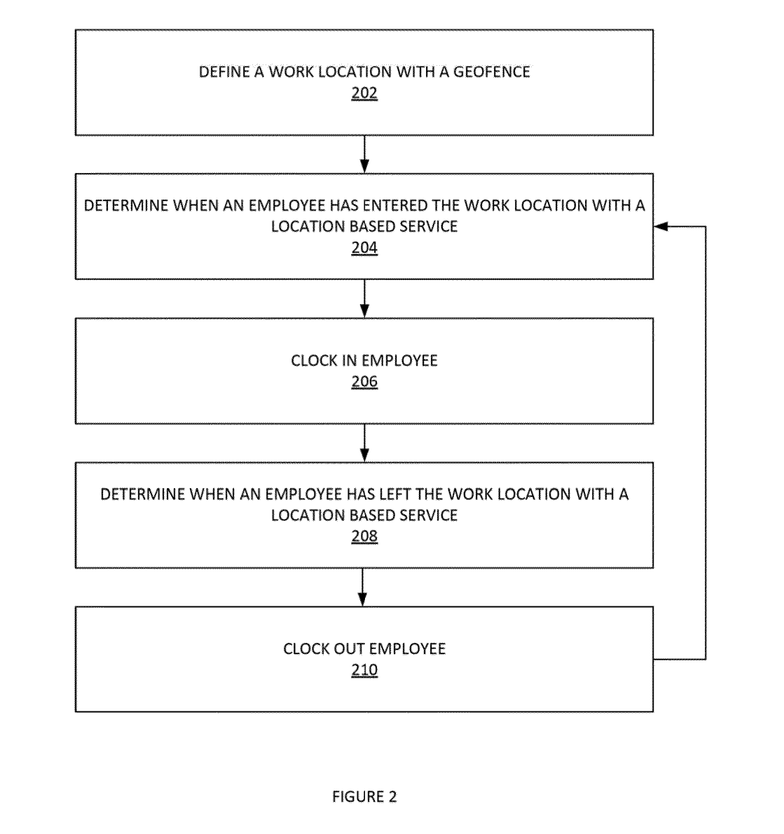

FIG. 2 depicts an example process 200 of geofence-based automatic time clocking, according to some embodiments. In step 202, a work location can be defined within a geofence. For example, see the region 402 defined in the user-interface view 400 provided infra. In step 204, it can be determined when an employee enters the work location. In step 206, the employee can be clocked in. While the employee is clocked-in, various attributes of the employee can be tracked with the LBS (e.g. speed, altitude, periods of non-movement, etc.). In step 208, it can be determined when an employee exits the work location. In step 210, the employee can be clocked out. Step 204-210 can be repeated.

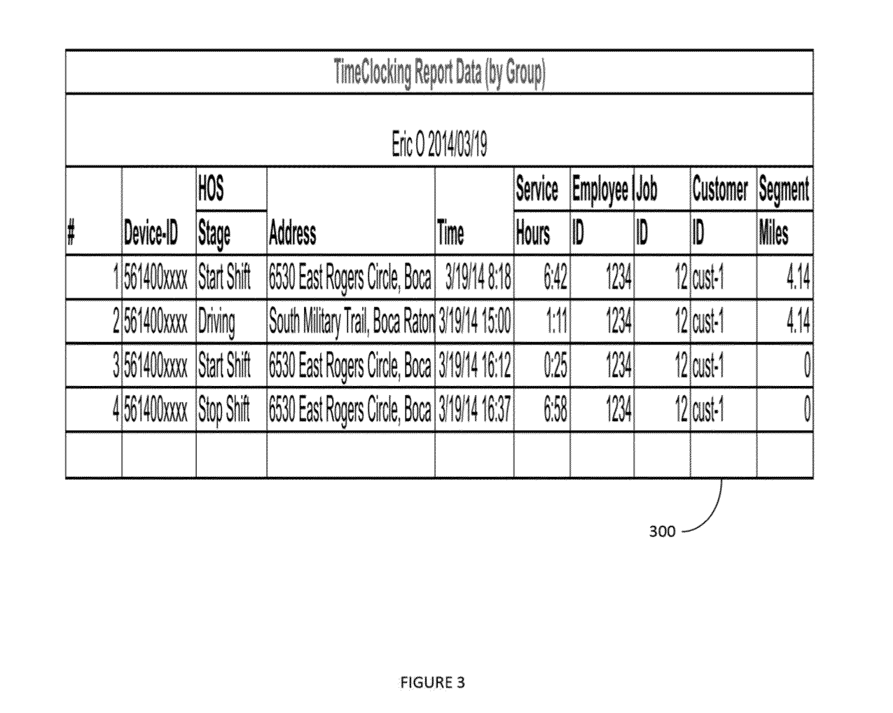

FIG. 3 illustrates an example report 300 generated by a geofence-based time clocking, according to some embodiments. Report 300 can be generated in a computer-readable form in step 110 of process 100. Report 300 can be generated by process 200 as well. Report 300 can include information such as, inter alia: a mobile device identifier, a type of each event, a location (e.g. an address) associated with each event, a time for each event, a duration of each event, an employee identifier associated with each event, a job identifier associated with each event, a customer identifier associated with each event, and/or distance attribute associated with each event. Report 300 is provided by way of example and not of limitation.

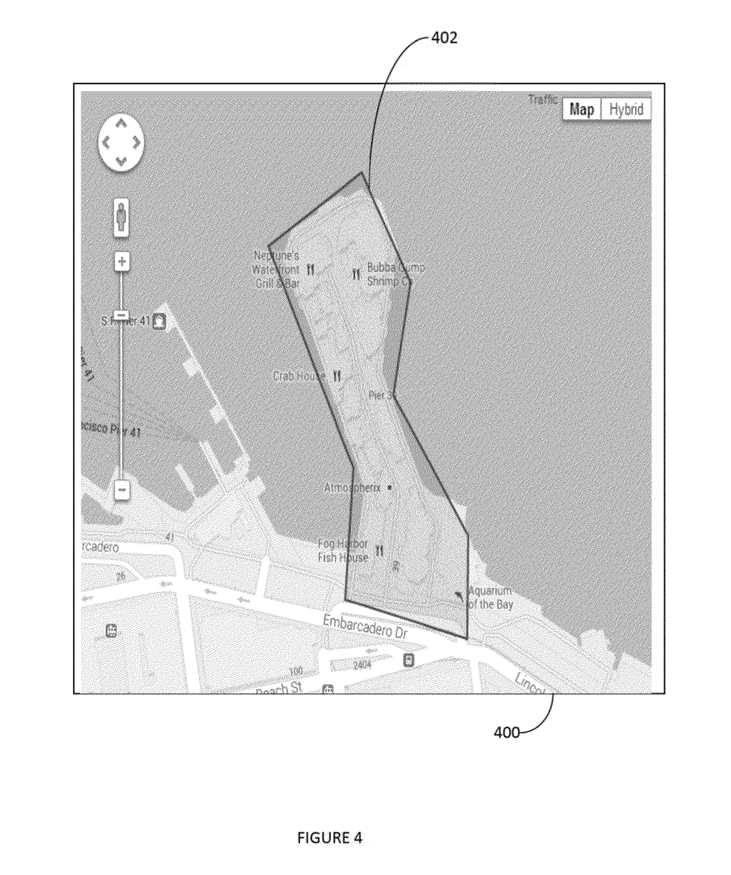

FIG. 4 illustrates an example user-interface view 400 of a region 402 defined by a geo-fencing methodology, according to some embodiments. The virtual boundaries can be view on the mapping service map. The user-interface view 400 can also include other information such as, inter alia: tracking of an employee phone; display of employees clock-in and/or clock out events; modifications to virtual boundaries, etc. User-interface view 400 can be provided via various methods and systems such as, inter alia: a web page, a mobile device screen view provided with a mobile device application, an augmented-reality image, etc. Supervisors can utilize the system that provides user-interface view 400 to perform various actions and access various information. For example, a supervisor (and/or other system administrator) can setup a daily tracking schedule for the employee mobile device. The supervisor can setup jobsites with customer code and/or payroll identifiers. The supervisor can automatically track start and/or stop events (e.g. clock-in and/or clock-out events) at a predetermined schedule. As a user (e.g. an employee) enters a jobsite, the service can automatically mark the entry as start of job shift. When the user leaves the job site mark it can be marked as clock-out event. It is noted that a clock out during middle of the day can be marked as a ‘lunch’ or other predefined event (e.g. offsite meeting, break, errand to purchase goods and/or services, etc.). This excused time outside the job site can be counted the same as time within the job site. An employee's calendar and/or ‘to do’ list can be automatically checked when the employee leaves a job site. If these files indicate that the employee has a valid reason (e.g. break, errand, etc.) to be outside of the job site, the system can continue the keep the employee in a clocked-in state. The system can create a daily report with hours worked at the end of the day or at another specified time. Supervisors can access various employee information on a real-time basis.

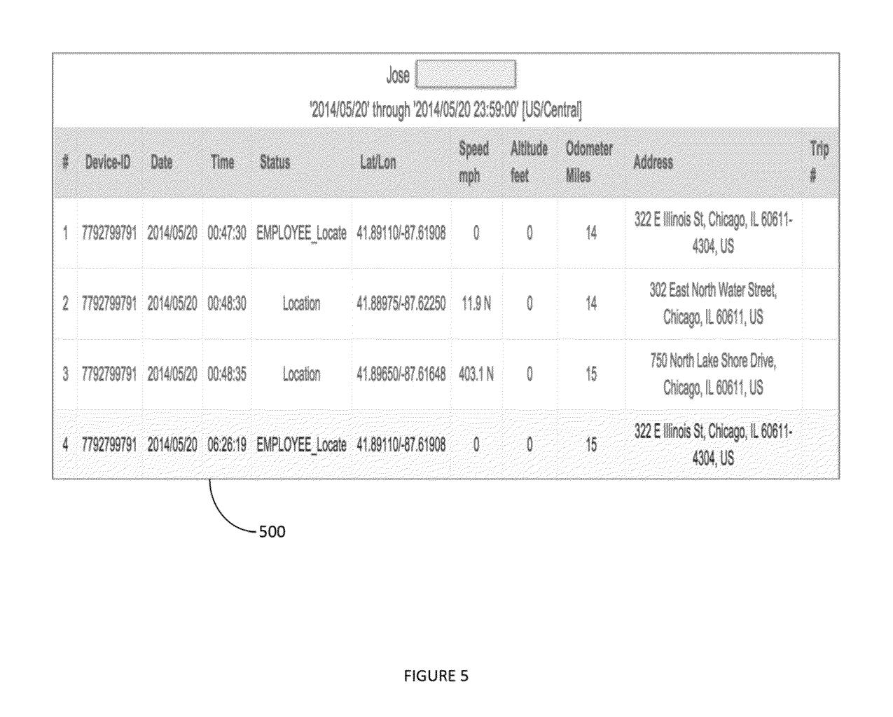

FIG. 5 illustrates an example employee attendance record 500 generated with geofence-based check-in and/or check-out service, according to some embodiments. A single employee's attendance record can be generated from information in a database maintained by the geofence-based check-in and/or check-out service. Attendance record 500 can be accessed by a customer of the geofence-based check-in and/or check-out service via an API and/or electronic message (e.g. emailed report, included in a text message, etc.). Attendance record 500 can include such information as, inter alia: device id, date, time, status, latitude/longitude, speed, altitude, odometer, address and/or trip number. The geofence-based check-in and/or check-out service can be automatically implemented with a computing system (e.g. one or more service, in a cloud-computing environment, etc.).

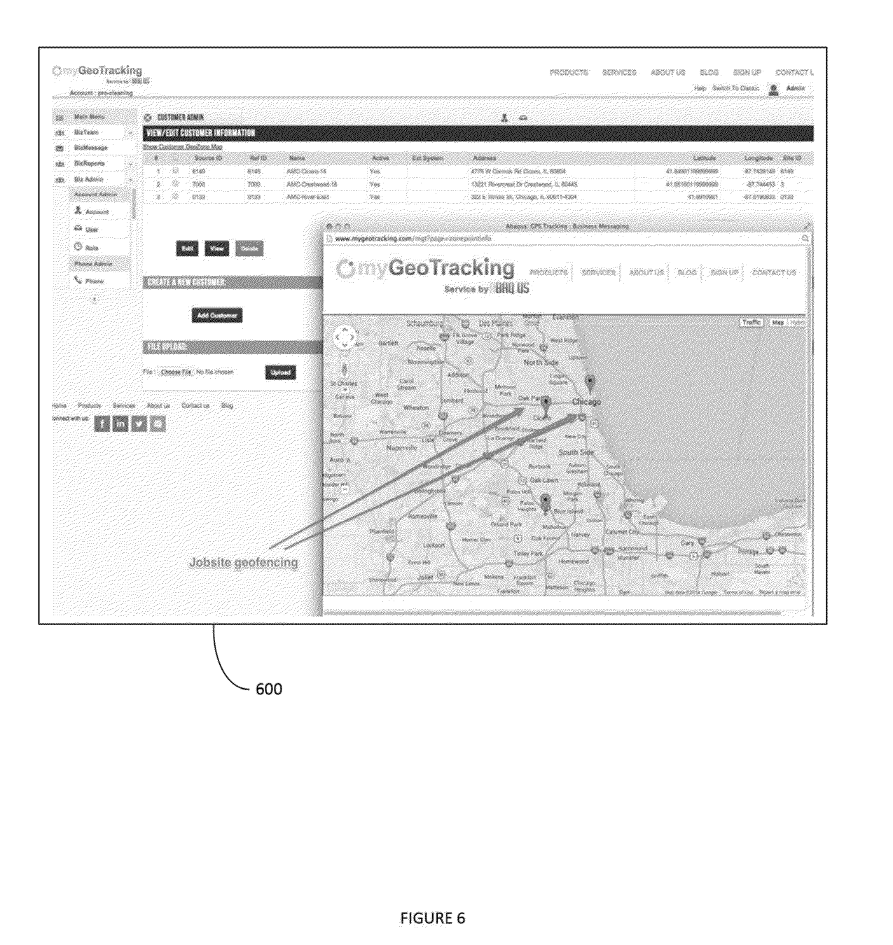

FIG. 6 illustrates an example user-interface view 600 that enables a user (e.g. a supervisor) to create various jobsites with geofence-based check-in and/or check-out events, according to some embodiments. Geofence regions can be created by various methods such as, inter alia: dragging and dropping various map coordinates (and/or other instructions) onto an image of a map, text input, pointer-based manipulation of map representations of virtual boundaries, dropping pins on a map and then defining areas around dropped pin, etc. In some examples, jobsite location can change dynamically (e.g. based on certain events such a location of repairs, deliveries, accidents, medical emergencies, nursing care, tutorials, education lessons, client visits, etc.). In these examples, a series of job sites can be defined in sequence and based on a schedule. The employee can record a check-in event by entering the job site only during a preset time slot (e.g. when a music lesson is schedule in a home, when an in-house patient exam is schedule in a home, when a delivery is schedule in an client's office, etc.).

FIG. 7 depicts an example user-interface view 700 that enables an employee to check-in and/or check-out of a jobsite using text messaging with geofence-based verification, according to some embodiments. For example, the employee can checks-in/checks-out using text message (e.g. an SMS, MMS, augmented-reality based text message, etc.). The message can include the text ‘#checkin’. The employee can add a customer site name/code such as ‘task ##checkin <customer-name><task>’. The system can perform a location lookup of the employee's mobile device to verify attendance at the geo-fenced jobsite. The hours of service report can be generated with hours worked, on break, driving etc. (e.g. see report 300 of FIG. 3).

Exemplary Environment and Architecture

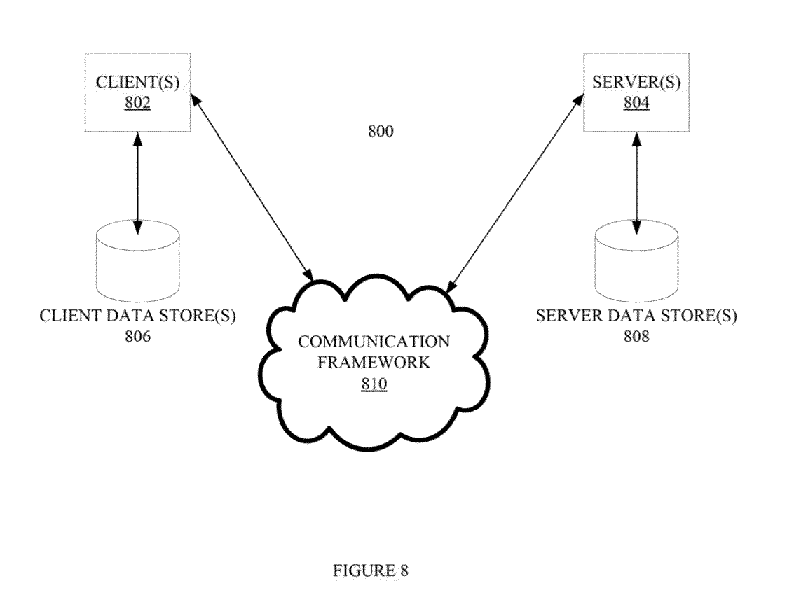

FIG. 8 is a block diagram of a sample computing environment 800 that can be utilized to implement some embodiments. The system 800 further illustrates a system that includes one or more client(s) 802. The client(s) 802 can be hardware and/or software (e.g., threads, processes, computing devices). The system 800 also includes one or more server(s) 804.

The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 810 that can be employed to facilitate communications between the client(s) 802 and the server(s) 804. The client(s) 802 are connected to one or more client data store(s) 806 that can be employed to store information local to the client(s) 802. Similarly, the server(s) 804 are connected to one or more server data store(s) 808 that can be employed to store information local to the server(s) 804.

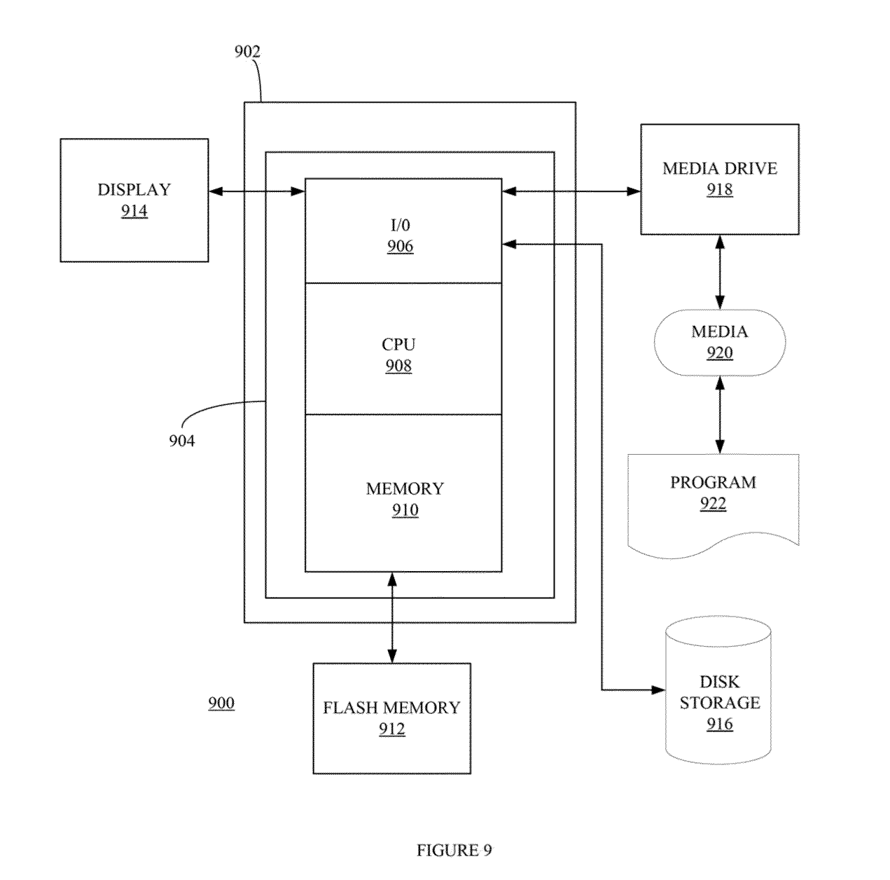

FIG. 9 depicts an exemplary computing system 900 that can be configured to perform any one of the processes provided herein. In this context, computing system 900 may include, for example, a processor, memory, storage, and L/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. For example, computing system 900 can be configured to be telecommunications server such as a payroll server and/or a location-aware geofence-based automatic time clocking server (e.g. can include API's and other systems to access data from the mobile device's network). In another example, computing system 900 can be configured as a mobile device and include such systems as may be typically included in a mobile device such as GPS systems, gyroscope, accelerometers, cameras, etc.

Additional Methods

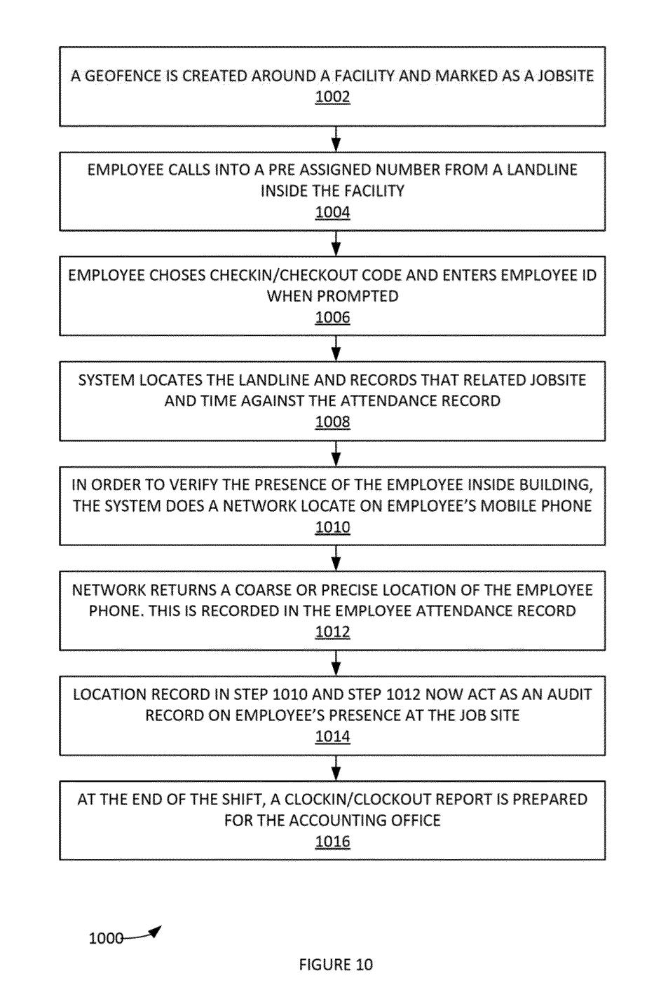

FIG. 10 illustrates an example process 1000 of using geofencing to generate a clock-in/clock-out report for an employee, according to some embodiments. In step 1002 of process 1000, a geofence is created around a facility and marked as a jobsite. In step 1004, an employee calls into a pre-assigned telephone number from a landline inside the facility. In step 1006, the employee chooses check-in/checkout code and enters Employee ID when prompted. In step 1008, the system locates the landline and records that related jobsite and time against the attendance record. In step 1010, in order to verify the presence of the employee inside the building, the system does a network locate on the employee's mobile phone. In step 1012, the network returns a coarse or precise location of the employee phone. This is recorded in the employee attendance record. In step 1014, the location record in step 1010 and step 102 can now act as an audit record on employee's presence at the job site. In step 1016, at the end of the shift, a clock-in/clock-out report is prepared for the accounting office. In one example, an employee ID can be used to lookup the mobile number of the employee. A network location can then be made against the mobile number of the employee. Additionally, in some examples, a company's scheduling system can be used to further enhance some of the automatic detection of activities throughout the day (e.g. such as check-in to a job site, lunch break, drive to pick up parts from Home Deport, etc.). The attendance record from of an activity list can be configured to feed into a company's payroll system.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising:
creating a virtual perimeter around a geographic region;
assigning the geographic region within the virtual perimeter a job-site number;
tracking a location of a user's mobile device;
determining when a user enters the geographic region defined by the virtual perimeter; and
recording the time that the user is in the geographic region;

2. The method of claim 1 further comprising:
assigning the time the user is in the virtual perimeter to a time sheet of the user as an employee of a company.

3. The method of claim 2, further comprising:
detecting that the user has left the geographic region; and
ceasing to record the time that the user is in the geographic region.

4. The method of claim 3, further comprising:
detecting that the user has left the geographic region;
determining that the user is utilizing an excused period to be outside the geographic region; and
continuing to record the time that the user is outside the geographic region for an excused period of time as time that the user is inside the geographic region.

5. The method of claim 4, wherein the excused period to be outside the geographic region is automatically determined from information in the user's mobile device calendar or in a list of assignments associated with the user.

6. The method of claim 5, wherein the geographic region comprises a physical work site.

7. The method of claim 6, wherein an aggregated time that the user is in the geographic region for a specified period is provided as payroll information for the user for the specified period.

8. A method comprising:
geofencing a geographic region;
receiving a telephonic communication from a landline telephone used by an employee, wherein the landline telephone is located in the geographic region;
receiving a check-in code from an employee input into the landline telephone during the telephonic communication;
receiving an employee identifier input into the landline telephone during the telephonic communication;
locating employee's mobile device;
determining that employee's mobile device is within the geographic region;
clocking in employee when both the check-in code from the landline telephone and the location of the mobile device indicate that the employee is within the geographic region.

9. The method of claim 8 further comprising:
marking the geographic region as a job site.

10. The method of claim 9, wherein the landline telephone comprises a pre-assigned landline telephone with a known telephone number.

11. The method of claim 10,
determining that the landline telephone is within the job site.

12. The method of claim 8 further comprising:
receiving a check-out code from an employee input into the landline telephone during a subsequent telephonic communication.

13. The method of claim 12 further comprising:
determining that employee's mobile device is outside of the geographic region after a specified period;
clocking out the employee.

14. A server system for implementing a location-aware advertisement campaign through text message comprising:
a processor configured to execute instructions;
a memory containing instructions when executed on the processor, causes the processor to perform operations that:
geofence a geographic region;
receive a telephonic communication from a landline telephone used by an employee, wherein the landline telephone is located in the geographic region;
receive a check-in code from an employee input into the landline telephone during the telephonic communication;
receive an employee identifier input into the landline telephone during the telephonic communication;
locate employee's mobile device;
determine that employee's mobile device is within the geographic region;
clock in employee when both the check-in code from the landline telephone and the location of the mobile device indicate that the employee is within the geographic region.

15. The server system of claim 14, wherein the memory containing instructions when executed on the processor, further causes the processor to perform operations that:
receive a check-out code from an employee input into the landline telephone during a subsequent telephonic communication;
determine that employee's mobile device is outside of the geographic region after a specified period;
clock out the employee.

16. The server system of claim 15, wherein the landline telephone comprises a pre-assigned landline telephone with a known telephone number.
